(19) United States
(12) Patent Application Publication
(10) Pub. No.: US 2006/0162419 A1
(43) Pub. Date: Jul. 27, 2006

(54) Measuring device with plausibility check

(75) Inventor: Bernd Rosskopf, Hausen (DE)

Correspondence Address: BACON & THOMAS, PLLC, 625 SLATERS LANE, FOURTH FLOOR, ALEXANDRIA, VA, 22314, US

(73) Assignee: Endress & Auser Gmbh + Co. KG, Maulburg (DE)

(21) Appl. No.: 10/518,544

(22) PCT Filed: Jul. 1, 2003
(86) PCT No.: PCT/EP03/06962

§ 371 Date: Feb. 2, 2006

(30) Foreign Application Priority Data
Jul. 2, 2002 (DE) 10229702.9

(51) Int. Cl. G01L 27/00; G01L 19/04; G01D 3/036

(52) U.S. Cl. 73/1.59; 73/708; 702/98; 702/99; 702/104; 702/116

(57) ABSTRACT

Disclosed is a transmitter which achieves a permanently high security standard in an inexpensive manner. The inventive transmitter comprises a set of identically built sensors (1, 21, 23) for measuring a physical parameter, a set of electronic circuits (5), each of which is assigned to a sensor (1) and conditions an electrical signal that is generated by the assigned sensor (1) and corresponds to the physical parameter, and an output unit (17, 25) to which the conditioned electrical signals of all sensors (1) are fed. Said output unit (17, 25) generates a measuring signal from the conditioned electrical signals, makes said measuring signal available for further evaluation, processing, and/or display, and generates information about the plausibility of the measuring signal and/or information about the operability of the individual sensors (1).

The invention relates to a transmitter for the measurement of a physical variable, for example, a pressure or a difference in pressure.

Transmitters are very widely used in measurement and control technology and are applied for control and/or regulation in nearly all branches of the processing industry. In the technology of measuring pressure, for example, transmitters for the measurement of pressures or pressure differences are utilized in many different applications, e.g. in the chemical industry, in the foods industry, in the automobile industry, and also in the field of water supply.

Transmitters have a sensor that registers a physical, measured variable and outputs an electric signal. The electric signal is conditioned in the transmitter and converted into a measurement signal that is accessible via the transmitter for further processing, evaluation, and/or display.

Depending on use, there are safety precautions to follow, such as regular maintenance of the transmitter, or reviewing its ability to function or the reliability of the measurement signals which it delivers. These safety precautions are involved and also expensive, since, as a rule, they require the presence of a technician on-site.

It is an object of the invention to provide a transmitter that offers a high standard of safety, longterm, and in a cost-effective manner.

To this end, the invention resides in a transmitter including:
a set of equally constructed sensors for measuring a physical variable,
a set of electronic circuits,
   each circuit being associated with a sensor,
   each circuit serving to condition an electric signal generated by its associated sensor, such signal corresponding to the physical variable, and
an output unit,
   to which the conditioned electric signals of all sensors are supplied,
   which produces a measurement signal from the conditioned electric signals and makes the measurement signal available for further evaluation, processing, and/or display, and
   which produces a statement concerning a plausibility of the measurement signal and/or a statement concerning a functional capability of the individual sensors.

In an embodiment, the measurement signal is an average value derived from the electric signals, especially a median or an arithmetic mean.

In another embodiment, the measurement signal is derived from the electric signals, with those signals that deviate from the remaining signals by more than a predetermined amount not being included.

In an embodiment, the sensors are pressure sensors, and a temperature sensor is associated with each set of one or more neighboring sensors.

In an embodiment of the last mentioned embodiment, the temperature sensors serve for a compensation of a temperature-dependent measurement-error.

In a further development, the evaluation unit serves for determining the plausibility of the temperature-dependent signals produced by the temperature sensors.

In an embodiment, the sensors are pressure sensors and, for the measurement of a difference between a first pressure and a second pressure, a first set of sensors for registering the first pressure and a second set of sensors for registering the second pressure are provided and the output unit computes the difference between the first pressure and the second pressure.

In an embodiment, the sensors are sensors produced in a batch process and arranged on a base plate.

In an embodiment of the last mentioned embodiment, the electronic circuits are arranged on the base plate.

In a further development, the transmitter issues a warning, if the functionality of a sensor falls short of a predetermined minimum.

In a further development, the transmitter issues an alarm, if plausibility and/or functionality fall(s) short of a predetermined minimum.

An advantage of the invention is that the transmitter monitors itself and issues an early warning in the case of threatening malfunction. In this way, maintenance tasks and function tests can be performed much more economically.

The invention and further advantages will now be explained in greater detail on the basis of the figures of the drawing, in which two examples of embodiments are presented. Equal elements are provided in the figures with equal reference characters.

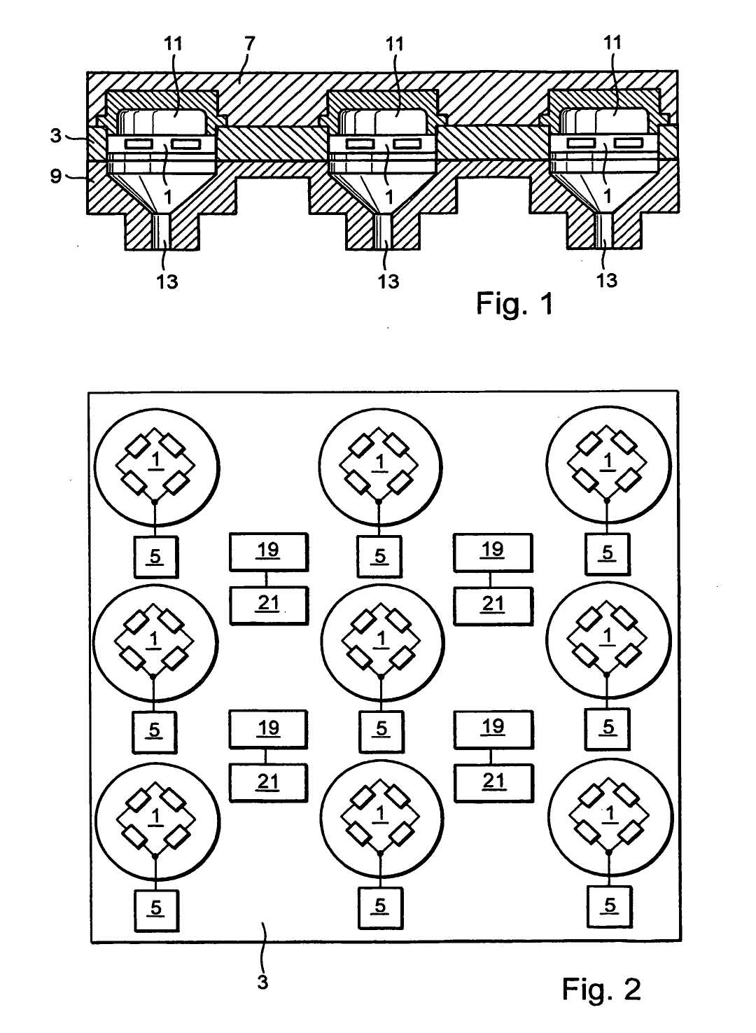

FIG. 1 shows a section through a transmitter of the invention;

FIG. 2 shows a view of the base plate having the sensors of the transmitter shown in FIG. 1;

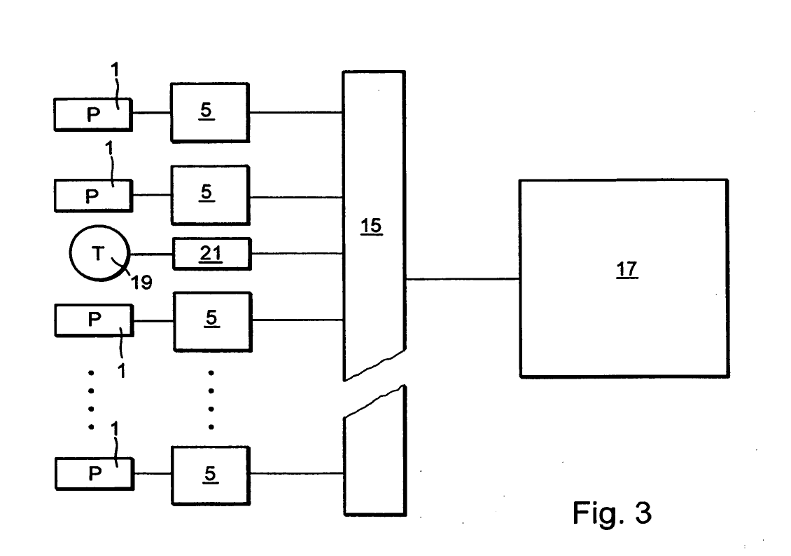

FIG. 3 shows a block diagram for the transmitter shown in FIG. 1; and

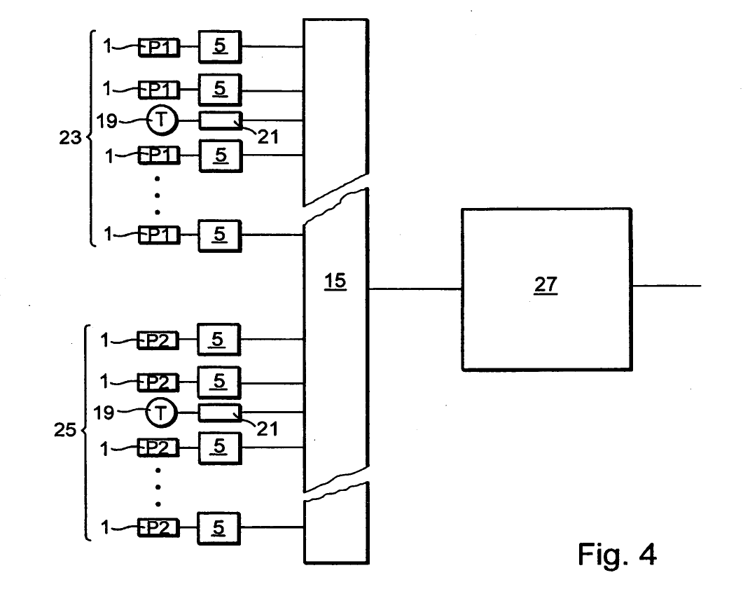

FIG. 4 shows a block diagram for a pressure-difference transmitter.

FIG. 1 shows a section through a transmitter of the invention. It has a housing (shown here merely schematically), in which a set of equally constructed sensors are enclosed. The sensors 1 are situated in a base plate 3, which is separately shown in FIG. 2, and serve for the registering of a physical variable.

In the illustrated example of an embodiment, the sensors 1 are pressure sensors. The physical variable is, consequently, a pressure supplied to the sensors 1. The sensors 1 have the shape of a pressure sensitive membrane, or diaphragm, integrated in the base plate 3. Introduced into the membrane are e.g. piezoresistive elements, which are e.g. connected together in the form of resistance measurement bridges. The sensors 1 are operated e.g. by feeding the resistance measurement bridges with current, or voltage, from the electronic circuits 5. The bridge voltage is a measure of the flexure of the relevant membrane, which is, in turn, a measure for the pressure acting on the membrane. The conditioning of the electric signal can e.g. be a pure amplification of the electric signal. It can, however, also involve a transformation of the signal, or a correction of a possibly present measurement error.

In the illustrated example of an embodiment, the housing is composed of two parts, a backing element 7 and a connection part 9. The backing element 7 provides a bearing surface for the base plate 3 and protects the sensors 1 from external influences. The backing element 7 has recesses 11 distributed according to the sensors 1, for accepting the chambers bordering the membranes. In these chambers, a reference pressure is established, against which the pressure p to be measured by the separate sensors 1 is referenced. The connection part 9 serves the purpose of supplying to each separate sensor 1 the pressure p to be measured. To this end, the connection part 9 covers the entire base plate 3 and has, where the sensors 1 are arranged, in each case a bore 13, through which the pressure to be measured is supplied to each sensor 1 located behind its associated bore 13.

FIG. 3 shows a block diagram for a transmitter of the invention. The separate sensors 1 produce electric signals, which are fed via connection lines to the electronic circuits 5. The signals of all sensors, conditioned by the electronic circuits 5, are fed e.g. via a multiplexer 15 to an output unit 17.

The output unit 17 produces from the conditioned electric signals a measurement signal and makes such available for a further evaluation, processing and/or display. Additionally, the output unit 17 produces a statement concerning a functional capability of the separate sensors 1. In this, the entering, conditioned, electric signals are preferably processed in digital form by a microprocessor.

In this example of an embodiment of a pressure transmitter, preferably a temperature sensor 19 is associated with each set of one, or more, neighboring pressure sensors. A signal corresponding to the temperature T at the sensing site is preferably conditioned by means of an electronic circuit 21 and fed to the output unit 17 via the multiplexer 15. The electronic circuits 21 preferably are likewise located on the base plate 3. The temperature measurement is used for compensating the separate electric signals, the conditioned electric signals and/or the final measurement signal with regard to a temperature-dependent measurement-error.

Preferably, the evaluation unit 17 serves for determining a plausibility of the temperature-dependent signals produced by the temperature sensors 19. This offers the advantage that only sufficiently plausible temperature-dependent signals are allowed for the compensation. The plausibility investigation proceeds e.g. by comparing all temperature-dependent signals with a median or an average of the same and e.g. those that deviate by more than a predetermined amount (e.g. an expected amount of scatter) from the median or average are not taken into consideration.

The measurement signal corresponds preferably to an average value derived from the electric signals of the separate sensors 1. Depending on application and sensor characteristics, e.g. a median or an arithmetic mean are suitable. By forming an average value, a higher accuracy and a greater reliability of the measurement result is achieved.

Preferably, in the derivation of the measurement signal, those signals deviating from the remaining signals by more than a predetermined amount are not considered. Such amount can be a small multiple of an amount of scatter of the signals to be expected on the basis of the measurement accuracy of the sensors. As reference point for this amount, e.g. the median can be used. Thus, if a signal lies away from the median by more than a small multiple of the amount of scatter to be expected, then it is not used for producing the measurement signal.

As statement concerning a plausibility of the measured value, an instantaneous amount of scatter of the separate electric signals can be determined by calculation and made available in or from the transmitter. In the case of determining this amount of scatter, preferably only those signals are considered, which are also used for determining the measurement signal. If, in this, less than a fixedly predetermined number of signals are available for such, then preferably, independently of the instantaneous amount of scatter of the signals, a low plausibility is determined. The fixedly predetermined number depends on the number of sensors 1 of the set and must be equal to, or larger than, three.

The statements concerning plausibility can e.g. be transmitted always in parallel with the signals or can be queried only as required by the user. Preferably, the transmitter has, for this purpose, an interface, via which a bidirectional communication is possible.

The functional capability of the separate sensors 1 is obtained from the deviation of their conditioned electric signals in comparison to the final measurement signal. If, in this, not only the instantaneous deviation is registered in the output unit 17, but also its plot over time, then e.g. a worsening of the measurement properties of a sensor 1 becomes evident. For recording the plot, it is not necessary to store every individual, instantaneous deviation. It is sufficient, if instantaneous deviations lying timewise far removed from one another are recorded.

Preferably, the transmitter issues a warning, when the functionality of a sensor 1 falls below a predetermined minimum functionality. In this way, it is recognizable early, when the measurement characteristics of the transmitter worsen. The user recognizes this, consequently, long before an acute call for action arises. Especially in large plants, where a multitude of transmitters is installed, their maintenance, e.g. replacement or repair, can, therefore, be cared for more economically.

In order that safety is at no time compromised, the transmitter additionally issues an alarm, when the plausibility of the measurement signal and/or functionality of a predetermined number of sensors falls below a predetermined minimum level. The predetermined number depends, also in this instance, on the number of sensors 1 in the set and must not be less than three.

The transmitter of the invention assures that, at all times, sufficient sensors 1 are fully functionally capable for producing a measurement signal of sufficient accuracy. In this way, the necessity for a technician on site is reduced. Times between maintenance can be significantly increased or maintenance need be done only in cases where such is necessary as recognized by the transmitter. In this way, significant costs can be saved, without incurring degradation of measurement accuracy and safety.

A pressure-difference transmitter can be embodied in completely analogous manner to the above-described pressure transmitters. In the case of a pressure-difference transmitter, the separate sensors 1 are likewise pressure sensors. They are used for measuring a pressure difference between a first pressure p1 and a second pressure p2. The totality of the available sensors 1 is divided into a first set of sensors 23 and a second set of sensors 25. The first set of sensors 23 serves for registering the first pressure p1 and the second set of sensors 25 for registering the second pressure p2. FIG. 4 shows a block diagram of a pressure-difference sensor of the invention. As in the case of the above-described pressure transmitter, the electric signals of the separate sensors 1 are conditioned by their associated electronic circuits 5 and fed via a multiplexer to an output unit 27. The output unit 27 determines the first and second pressures p1, p2 accurately, as the output unit 17 of the pressure transmitter determined the pressure p. Then, the output unit 27 calculates the difference between the first and second pressures p1, p2, and makes the result available as measurement signal for a further evaluation, processing and/or display.

The plausibility of the measurement signal is obtained from the plausibility of the separately determined pressures p1, p2, and the functionality is also determined here separately for each sensor 1. Warning and alarm are issued separately for each set of sensors 23, 25.

Transmitters of the invention can be produced in especially economical manner by using sensors, e.g. semiconductor sensors, produced in a batch process. These sensors are already located on a base plate 3 as a result of the manufacturing process, such plate being the carrier used in the batch process. The electronic circuits 5, 21 are preferably likewise worked into the carrier. These sensors 1 offer the advantage that the carrier of the batch process can be directly installed into the housing of the transmitter.

1-11. (canceled)

12. A transmitter, comprising:
a set of equally constructed sensors for measuring a physical variable;
a set of electronic circuits, each of which is associated with a sensor, which serve to condition an electric signal, generated by the associated sensor and corresponding to the physical variable; and
an output unit, to which the conditioned electric signals of all said sensors are supplied, wherein said output unit:
produces a measurement signal from the conditioned electric signals and makes it available for further evaluation, processing, and/or display; and
produces a statement concerning the plausibility of the measurement signal and/or a statement concerning the functional capability of individual sensors.

13. The transmitter as claimed in claim 12, wherein:
the measurement signal is an average value derived from the electric signals, particularly a median or an arithmetic mean.

14. The transmitter as claimed in claim 12, wherein:
the measurement signal is derived from the electric signals, and those signals that deviate from the remaining signals by more than a predetermined amount are not considered.

15. The transmitter as claimed in claim 12, further comprising:
a temperature sensor associated with each set of one or more neighboring sensors, wherein:
said sensors are pressure sensors.

16. The transmitter as claimed in claim 15, wherein: said temperature sensors serve for compensation of a temperature-dependent measurement-error.

17. The transmitter as claimed in claim 15, wherein:
said evaluation unit serves for determining a plausibility of temperature-dependent signals produced by said temperature sensors.

18. The transmitter as claimed in claim 12, wherein:
said sensors are pressure sensors and, for measuring a pressure-difference between a first pressure (p1) and a second pressure (p2), a first set of sensors is provided for registering the first pressure (p1) and a second set of sensors is provided for registering the second pressure (p2); and
said output unit calculates the difference between the first pressure (p1) and the second pressure (p2).

19. The transmitter as claimed in claim 12, wherein:
said sensors are sensors produced in a batch process and arranged on a base plate.

20. The transmitter as claimed in claim 19, wherein:
said electronic circuits are arranged on said base plate.

21. The transmitter as claimed in claim 12, wherein:
the transmitter issues a warning, if the functionality of a sensor falls short of a predetermined minimum functionality.

22. The transmitter as claimed in claim 12, wherein:
the transmitter issues an alarm, if plausibility and/or functionality fall short of a predetermined minimum.
